(19) United States
(12) Patent Application Publication
(10) Pub. No.: US 2017/0371801 A1
(43) Pub. Date: Dec. 28, 2017

(54) INFORMATION PROCESSING APPARATUS AND INFORMATION PROCESSING METHOD

(71) Applicant: FUJITSU LIMITED, Kawasaki-shi (JP)

(72) Inventors: Tetsuya Watanabe, Numazu (JP); Kadohito Ohsuga, Numazu (JP); Masaki Nakajima, Numazu (JP)

(73) Assignee: FUJITSU LIMITED, Kawasaki-shi (JP)

(21) Appl. No.: 15/601,065

(22) Filed: May 22, 2017

(30) Foreign Application Priority Data
Jun. 22, 2016 (JP) 2016-123677

(51) Int. Cl. G06F 12/10; G06F 17/30; G06N 99/00

(52) U.S. Cl. CPC G06F 12/10; G06N 99/005; G06F 17/30988; G06K 2209/01

(57) ABSTRACT

An information processing apparatus includes a memory and a processor coupled to the memory. The memory is configured to store device connection information indicating a connection destination device coupled to a first device among a plurality of devices included in a communication network. The processor is configured to: search physical address learning information of the connection destination device in preference to physical address learning information of search target devices other than the connection destination device on basis of the device connection information. The physical address learning information of a specific device includes physical addresses learned for every port of the specific device. The search target devices are the plurality of devices other than the first device. The processor is configured to: obtain a connection destination port coupled to a first port of the first device on basis of a result of the search.

### CROSS REFERENCE TO RELATED APPLICATION

This application is based upon and claims the benefit of priority of the prior Japanese Patent Application No. 2016-123677, filed on Jun. 22, 2016, the entire contents of which are incorporated herein by reference.

### FIELD

The embodiment discussed herein is related to an information processing apparatus and an information processing method.

### BACKGROUND

In an operation management of a communication network, the following methods are known for registering connection information indicating a physical connection between a plurality of devices included in the communication network:

(a) a method of registering connection information by automatic search using a media access control (MAC) learning table,

(b) a method of registering connection information by automatic search using a discovery protocol such as a link layer discovery protocol (LLDP) or a neighbor discovery protocol (NDP), and

(c) a method of manually registering connection information using a graphical user interface (GUI) or a command line interface (CLI).

In the MAC learning table of each device, a MAC address learned for each port of the device is registered.

Related technologies are disclosed in, for example, Japanese Laid-Open Patent Publication No. 2005-348051.

When the registration method (a) is employed, it is considered that the processing time increases as the number of devices included in the communication network increases.

The above-mentioned problem may be incurred not only when the MAC learning table is used, but also when other physical address learning information including a physical address which is learned for each port of the device is used.

### SUMMARY

According to an aspect of the present invention, provided is an information processing apparatus including a memory and a processor coupled to the memory. The memory is configured to store device connection information indicating a connection destination device coupled to a first device among a plurality of devices included in a communication network. The processor is configured to: search physical address learning information of the connection destination device in preference to physical address learning information of search target devices other than the connection destination device on basis of the device connection information. The physical address learning information of a specific device includes physical addresses learned for every port of the specific device. The search target devices are the plurality of devices other than the first device. The processor is configured to: obtain a connection destination port coupled to a first port of the first device on basis of a result of the search.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary functional configuration of an information processing apparatus;

FIG. 2 is a flowchart illustrating a flow of a search process;

FIG. 3 is a diagram illustrating an exemplary functional configuration of an information processing apparatus;

FIG. 4 is a diagram illustrating a communication network;

FIG. 5 is a diagram illustrating search range information;

FIG. 6 is a diagram illustrating devices in a search range;

FIG. 7 is a diagram illustrating device connection information;

FIG. 8 is a diagram illustrating a MAC learning table;

FIG. 9 is a diagram illustrating MAC learning table management information;

FIG. 10 is a diagram illustrating MAC address management information;

FIG. 11 is a diagram illustrating link information;

FIG. 12 is a flowchart illustrating a flow of a search process;

FIG. 13 is a flowchart illustrating a flow of a device connection information generation process;

FIG. 14A is a flowchart illustrating a flow of a topology search process;

FIG. 14B is a flowchart illustrating a flow of a topology search process;

FIG. 15 is a diagram illustrating search target array; and

FIG. 16 is a diagram illustrating an exemplary hardware configuration of an information processing apparatus.

### DESCRIPTION OF EMBODIMENT

Hereinafter, an embodiment will be described in detail with reference to the drawings.

Recently, in accordance with the development of cloud computing and software-defined networking (SDN), various types of devices form a communication network, and various devices including a virtual machine and a virtual appliance are coupled to each other through the communication network. Due to the increase of devices included in the communication network, there have been performance problems in the operation management of the related art. For example, the above-described method of registering connection information has the following characteristics:

When the registration method (a) is employed, every L2 switch maintains the MAC learning table, so that versatility of the registration method is high. In addition, no particular setting is required, so that a load on a user is small. However, since all the MAC learning tables existing in the search range are compared in a round-robin manner, the processing time increases.

When the registration method (b) is employed, no particular setting is required, so that the load on the user is small, and only discovery protocol information maintained by the device is referred to. Therefore, the processing time is shorter than that of the registration method (a). However, since some devices may not respond to the discovery protocol, and a communication network in a multivendor environment may not be appropriately operated, the versatility of the registration method is low.

When the registration method (c) is employed, only information input by the user is used, so that the versatility of the registration method is high, and the processing time is short. However, the load on the user is significantly large as compared with that of the registration method (a) or (b).

As described above, a registration method having high versatility and a small load on the user is the registration method (a), but the registration method (a) has a problem in that the processing time is relatively long. It is considered that as the number of devices included in the communication network increases, the processing time increases.

For example, in some topology search methods of the related art, an inter-switch connection search process is performed with a port having a MAC learning number of two or more serving as a connection source port, and a connection destination port which is coupled to the connection source port is searched for. When there are N switches in the search range, the maximum number of search target switches which are searched to determine the connection destination port coupled to one connection source port is N−1. Therefore, as the number of switches increases, the processing time of the inter-switch connection search process increases.

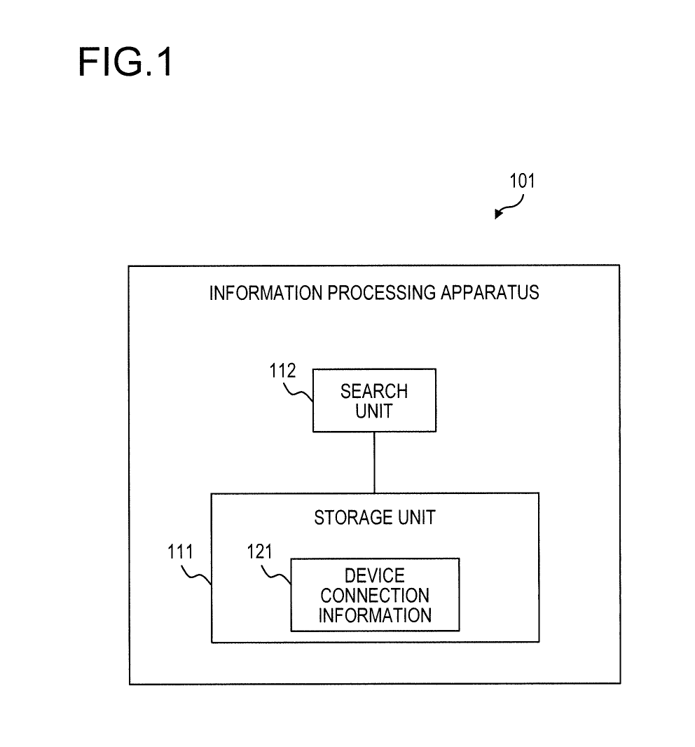

FIG. 1 illustrates an exemplary functional configuration of an information processing apparatus (computer) according to the embodiment. The information processing apparatus 101 of FIG. 1 includes a storage unit 111 and a search unit 112. The storage unit 111 stores therein device connection information 121 indicating a connection destination device coupled to a specific device among a plurality of devices included in a communication network. The search unit 112 obtains a connection destination port coupled to a specific port of the specific device by referring to the device connection information 121.

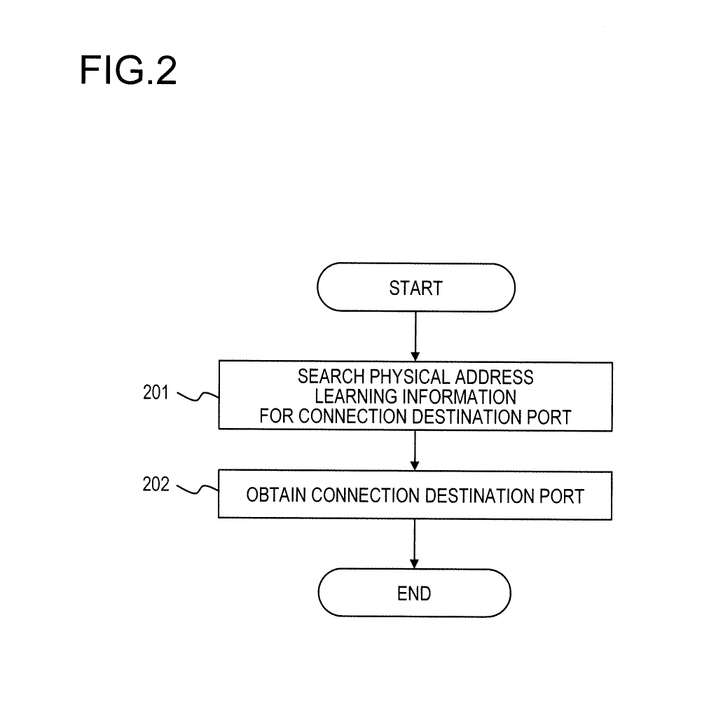

FIG. 2 is a flowchart illustrating an example of a search process performed by the information processing apparatus 101 of FIG. 1. First, the search unit 112 searches physical address learning information including a physical address learned for each port of the remaining devices other than the specific device (201). At this time, the search unit 112 searches the physical address learning information of the connection destination device in preference to the physical address learning information of the remaining devices other than the connection destination device, based on the device connection information 121. Then, the search unit 112 obtains a connection destination port coupled to the specific port of the specific device, based on the search result (202).

According to the above-described information processing apparatus 101, a connection destination port coupled to a port of a device included in a communication network may be obtained at a high speed.

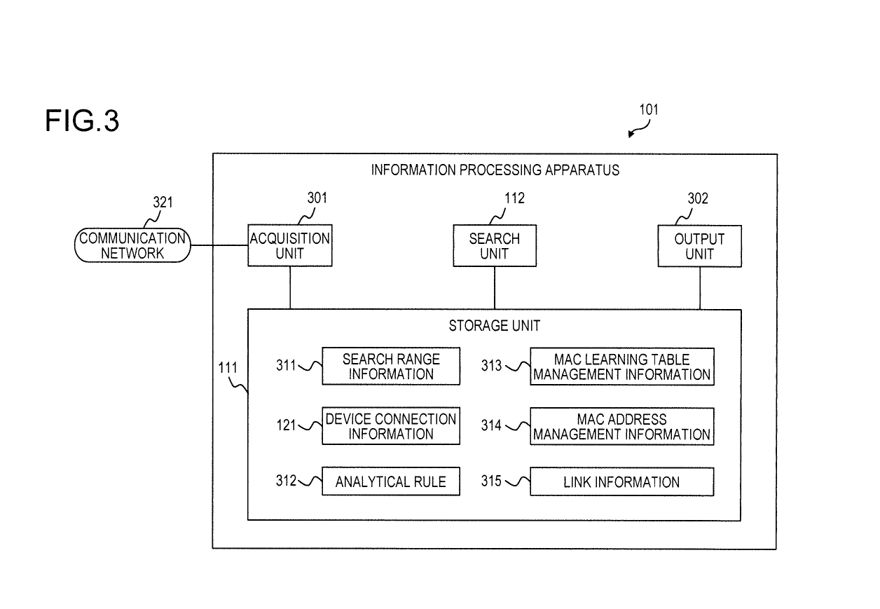

FIG. 3 illustrates a specific example of the information processing apparatus 101 of FIG. 1. The information processing apparatus 101 of FIG. 3 includes a storage unit 111, a search unit 112, an acquisition unit 301, and an output unit 302. The storage unit 111 stores therein the device connection information 121, search range information 311, analytical rules 312, MAC learning table management information 313, MAC address management information 314, and link information 315. In the information processing apparatus 101 of FIG. 3, the MAC address and the MAC learning table are used as the physical address and the physical address learning information, respectively.

The device connection information 121 is information indicating a connection relationship between devices included in a communication network 321, and does not necessarily include a connection relationship between ports. The search range information 311 is information indicating a search range in the communication network 321. The device connection information 121 and the search range information 311 are, for example, input to the information processing apparatus 101 by the user and stored in the storage unit 111. Each of the analytical rules 312 is information indicating a description format of a management information base (MIB) of a device included in the communication network 321, and thus, different analytical rules 312 for respective types of device are stored in the storage unit 111.

The MAC learning table management information 313 is information registered in the respective MAC learning tables of a plurality of devices included in the communication network 321 and the MAC address management information 314 is information indicating a MAC address of a port of each device. The link information 315 is information indicating a physical connection relationship between ports of the plurality of devices obtained by the search process.

The acquisition unit 301 acquires the MAC learning table and the MAC address from each device in the search range indicated by the search range information 311, among the devices included in the communication network 321. The acquisition unit 301 stores the information registered in the acquired MAC learning table in the storage unit 111 as the MAC learning table management information 313 and stores the acquired MAC address in the storage unit 111 as the MAC address management information 314.

When the device connection information 121 is not input by the user, the acquisition unit 301 generates the device connection information 121 by a method using a protocol such as a discovery protocol or an L2 trace route or a method of reading a network diagram from an external device. The acquisition unit 301 stores the generated device connection information 121 in the storage unit 111. The network diagram is, for example, created by a computer-aided design (CAD) and stored in the external device.

According to the method using a discovery protocol, the acquisition unit 301 acquires information indicating a connection relationship between devices from each device and analyzes the acquired information using the analytical rules 312 to generate the device connection information 121.

The search unit 112 performs the search process by referring to the device connection information 121, the MAC learning table management information 313, and the MAC address management information 314, generates the link information 315 on the basis of the search result, and stores the generated link information 315 in the storage unit 111. The output unit 302 outputs the link information 315 to a display screen of the information processing apparatus 101 or an external information processing apparatus.

The communication network 321 includes a server device which provides an information processing service, a terminal device which uses the information processing service, and a network device which transfers data. The terminal device may be a personal computer (PC), and the network device may be a switch or a router. Each device may be referred to as a node.

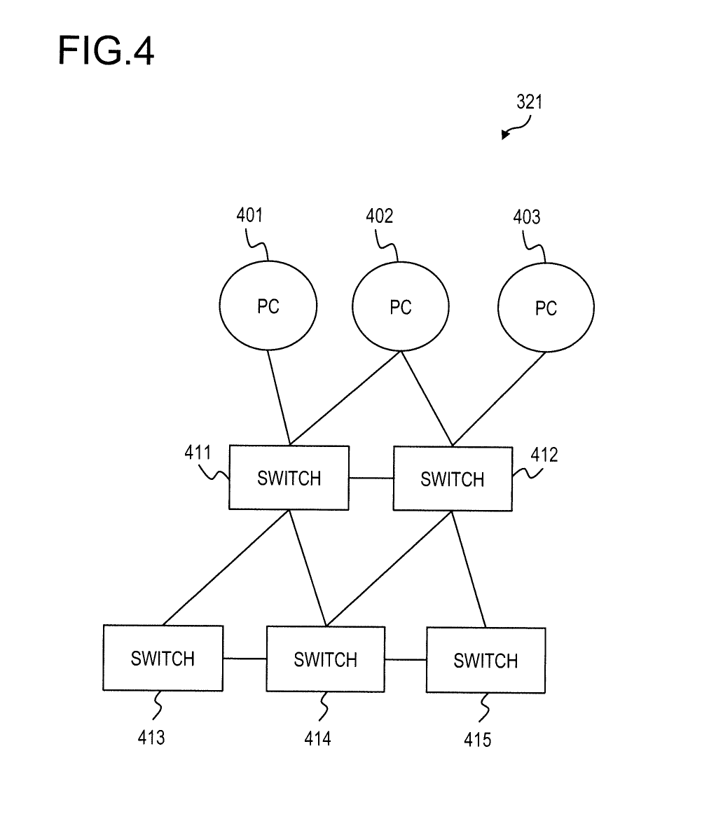

FIG. 4 illustrates an example of the communication network 321. The communication network 321 of FIG. 4 includes PCs 401 to 403 and switches 411 to 415.

The PC 401 is coupled to the switch 411, the PC 402 is coupled to the switches 411 and 412, and the PC 403 is coupled to the switch 412. The switch 411 is coupled to the PCs 401 and 402 and the switches 412 to 414, and the switch 412 is coupled to the PCs 402 and 403 and the switches 411, 414, and 415.

The switch 413 is coupled to the switches 411 and 414, the switch 414 is coupled to the switches 411 to 413, and 415, and the switch 415 is coupled to the switches 412 and 414.

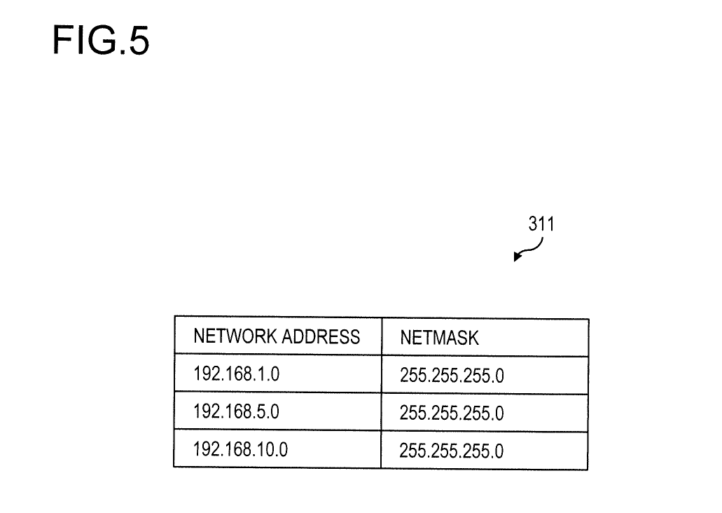

FIG. 5 illustrates an example of the search range information 311. Each entry of the search range information 311 of FIG. 5 includes a network address and a netmask. In this case, the search range may be designated in units of an Internet protocol (IP) address, and the network address of the search range may be obtained by an AND operation with the specific IP address and the netmask.

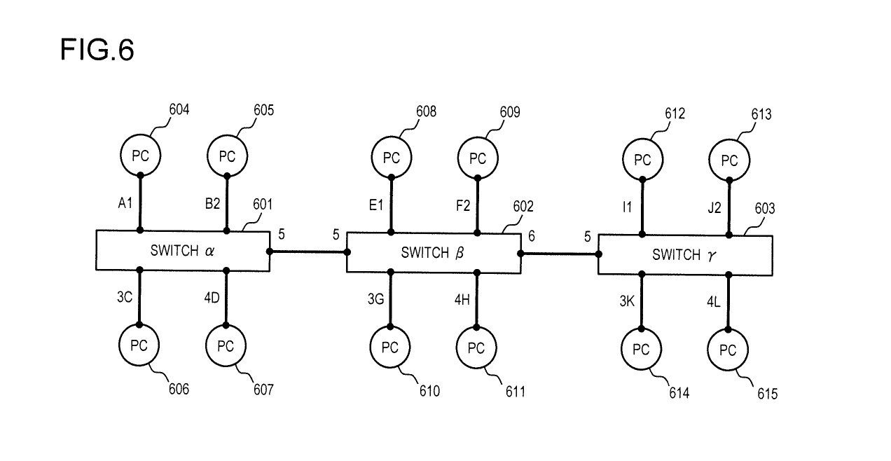

FIG. 6 illustrates an example of devices in a search range. In the search range of FIG. 6, switches 601 to 603 and PCs 604 to 615 are included. Identification information of the switches 601, 602, and 603 is α, β, and γ, respectively. MAC addresses of the PCs 604 to 615 are A to L, respectively.

The switch 601 (switch α) has ports 1 to 5. The PCs 604, 605, 606, and 607 are coupled to the ports 1 to 4, respectively, and the switch 602 is coupled to the port 5.

The switch 602 (switch β) has ports 1 to 6. The PCs 608, 609, 610, and 611 are coupled to the ports 1 to 4, respectively, and the switches 601 and 603 are coupled to the port 5 and port 6, respectively.

The switch 603 (switch γ) has ports 1 to 5. The PCs 612, 613, 614, and 615 are coupled to the ports 1 to 4, respectively, and the switch 602 is coupled to the port 5.

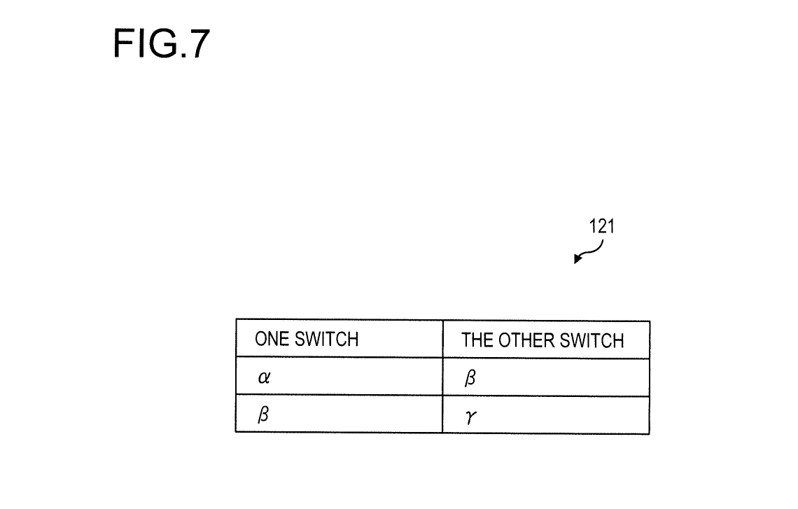

FIG. 7 illustrates an example of the device connection information 121 for the switches 601 to 603 of FIG. 6. Each entry of the device connection information 121 of FIG. 7 includes identification information of one switch and the other switch which are coupled to each other. The first entry indicates that the switch α and the switch β are coupled (adjacent) to each other and the second entry indicates that the switch β and the switch γ are coupled.

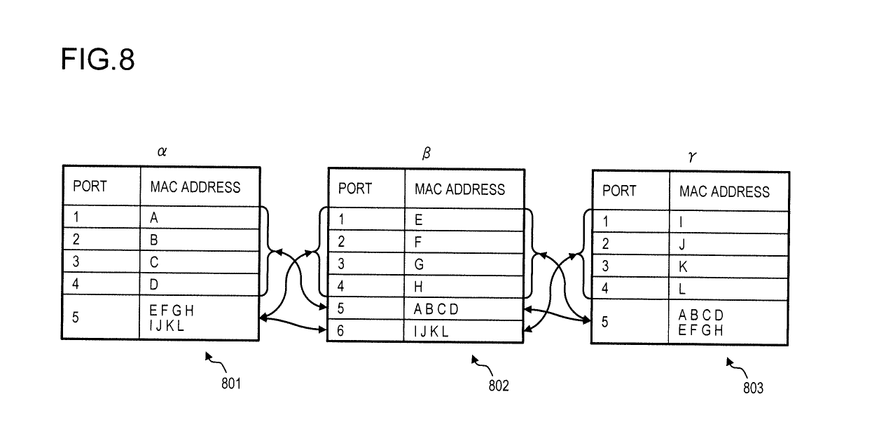

FIG. 8 illustrates an example of the MAC learning tables maintained by the switches 601 to 603 of FIG. 6. MAC learning tables 801 to 803 are MAC learning tables of the switches 601 to 603, respectively. Each entry of each MAC learning table includes identification information of a port and one or more MAC addresses learned for the port.

When a specific port of a specific switch is coupled to a connection destination port of a connection destination switch, the MAC addresses learned for the specific port is an aggregation of MAC addresses learned for ports of the connection destination switch other than the connection destination port.

For example, the MAC address learned for the port 5 of the switch α is MAC addresses E to L learned for the ports 1 to 4 and 6 of the switch β other than the port 5 coupled to the port 5 of the switch α. MAC addresses are learned for the ports 5 and 6 of the switch β and the port 5 of the switch γ, similarly to the port 5 of the switch α.

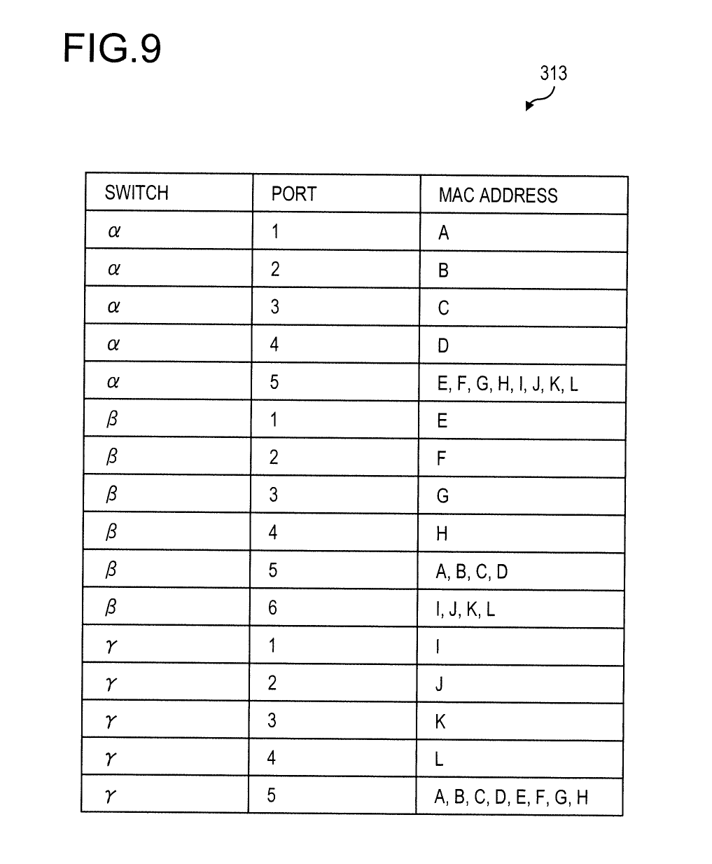

FIG. 9 illustrates an example of the MAC learning table management information 313 generated from the MAC learning tables 801 to 803 of FIG. 8. Each entry of the MAC learning table management information 313 of FIG. 9 includes identification information of a switch, identification information of a port, and one or more MAC addresses learned for the port.

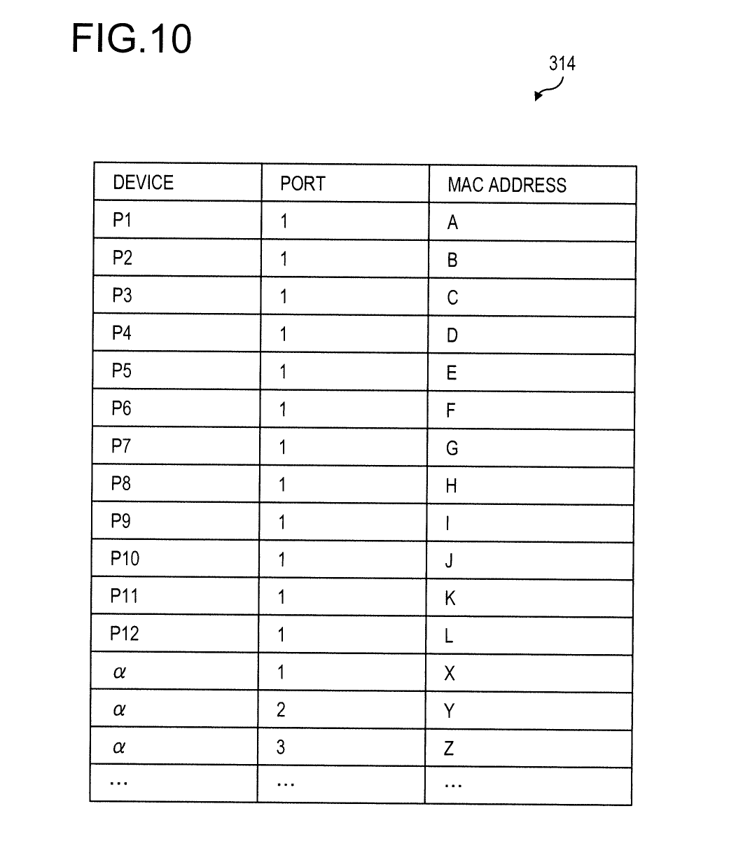

FIG. 10 illustrates an example of the MAC address management information 314 including the MAC addresses of the ports of the switches 601 to 603 and the PCs 604 to 615 of FIG. 6. Each entry of the MAC address management information 314 of FIG. 10 includes identification information of a device, identification information of a port, and a MAC address of the port.

P1 to P12 are identification information of the PCS 604 to 615, respectively. MAC addresses of the port 1 of the PCs P1 to P12 are A to L, respectively. MAC addresses of the ports 1 to 3 of the switch α are X to Z, respectively.

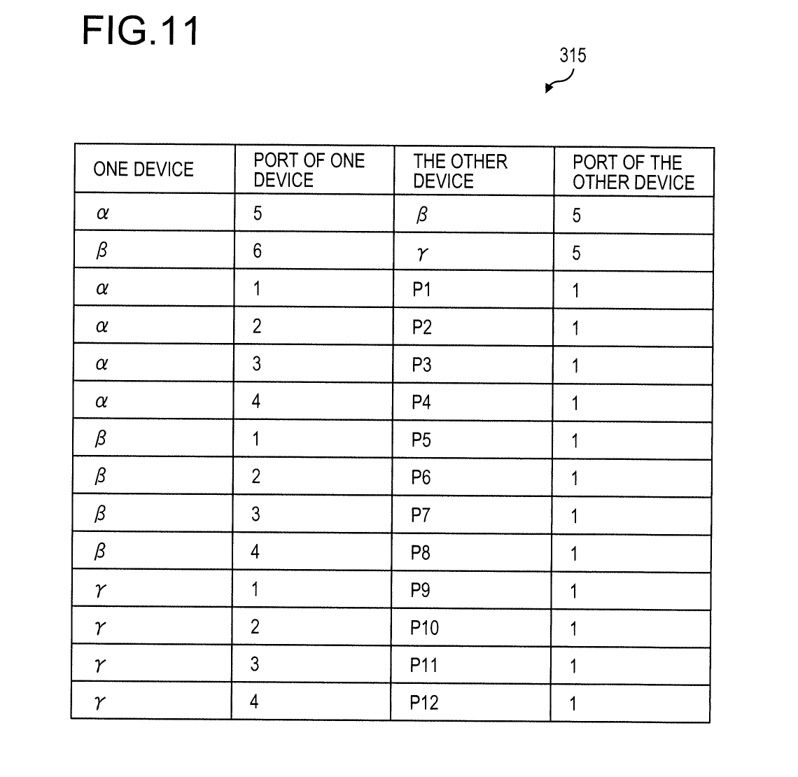

FIG. 11 illustrates an example of the link information 315 generated from the device connection information 121 of FIG. 7, the MAC learning table management information 313 of FIG. 9, and the MAC address management information 314 of FIG. 10. Each entry of the link information 315 of FIG. 11 includes identification information of one device and the other device and identification information of a port of one device and a port of the other device which are coupled to each other.

For example, the first entry indicates that the port 5 of the switch α and the port 5 of the switch β are coupled to each other. The second entry indicates that the port 6 of the switch β and the port 5 of the switch γ are coupled to each other. The third entry indicates that the port 1 of the switch α and the port 1 of the PC P1 are coupled to each other.

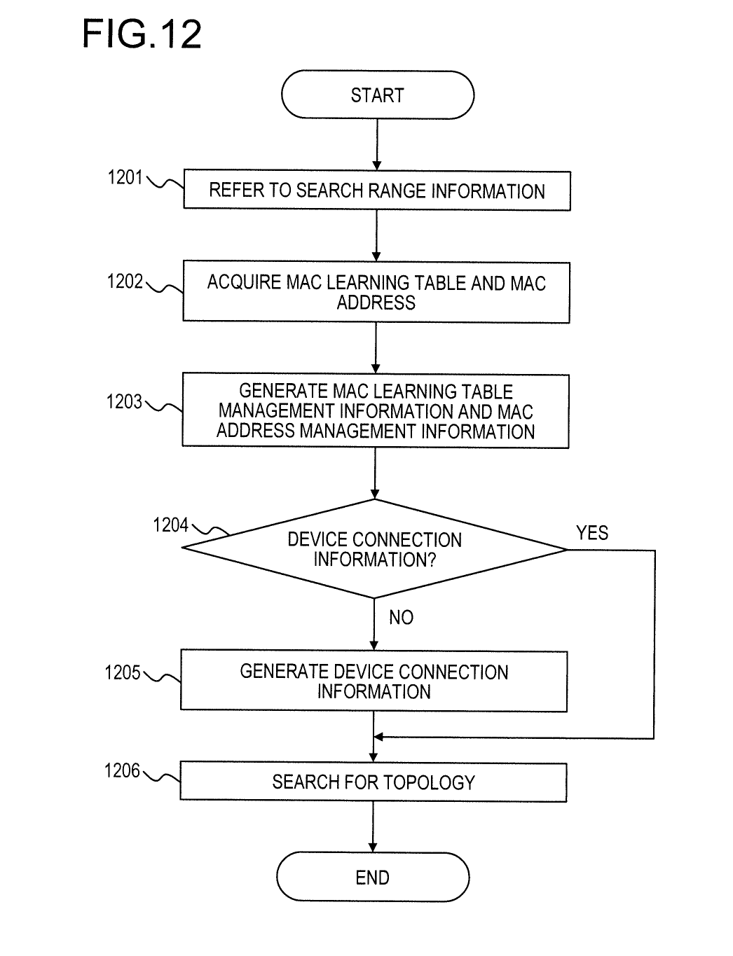

FIG. 12 is a flowchart illustrating a flow of a search process performed by the information processing apparatus 101 of FIG. 3. First, the acquisition unit 301 refers to the search range information 311 (1201) to acquire the MAC learning table and the MAC address from the devices within the search range indicated by the search range information 311 (1202). The acquisition unit 301 generates the MAC learning table management information 313 from the information registered in the acquired MAC learning table and generates the MAC address management information 314 from the acquired MAC address (1203).

Next, the acquisition unit 301 checks whether the device connection information 121 is input by the user (1204). When it is determined that the device connection information 121 is not input (NO in 1204), the acquisition unit 301 acquires information indicating the connection relationship between devices from each device and generates the device connection information 121 from the acquired information (1205).

Next, the search unit 112 performs a topology search process by referring to the device connection information 121, the MAC learning table management information 313, and the MAC address management information 314 (1206). When it is determined that the device connection information 121 is input (YES in 1204), the search unit 112 performs the processing of 1206 by referring to the device connection information 121.

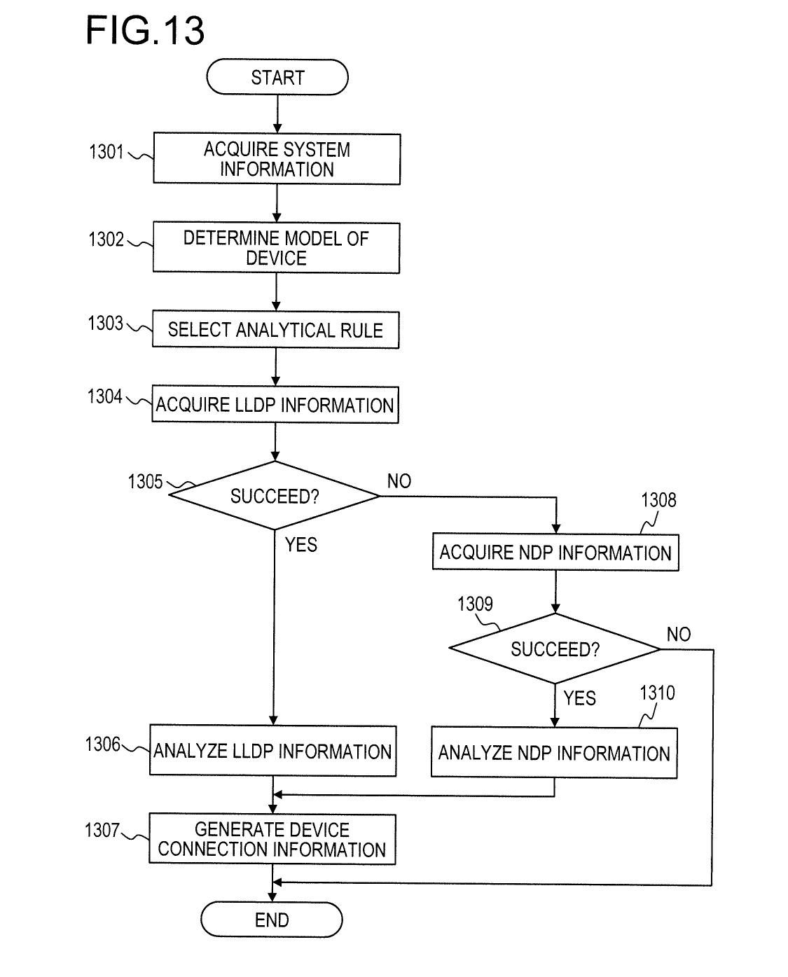

FIG. 13 is a flowchart illustrating an example of a device connection information generation process in 1205 of FIG. 12. In the device connection information generation process of FIG. 13, the device connection information 121 is generated using the discovery protocol.

First, the acquisition unit 301 acquires system information including device identification information from each device by a simple network management protocol (SNMP) (1301) and determines a type of each device on the basis of the system information (1302). As the type of device, for example, a switch or a router is used. The acquisition unit 301 selects an analytical rule 312 corresponding to the determined type (1303). In an analytical rule 312 corresponding to a specific type, a description format of an MIB for the type of device is defined.

Next, the acquisition unit 301 acquires LLDP information managed as an MIB from each device by the SNMP (1304) and checks whether the LLDP information is successfully acquired (1305). For example, the LLDP information includes identification information of a device, identification information of each port, and identification information of a port of another device coupled to the port, which are defined by the SNMP.

When it is determined that the LLDP information is successfully acquired (YES in 1305), the acquisition unit 301 analyzes the LLDP information in accordance with the selected analytical rule 312 to extract a connection relationship between devices from the LLDP information (1306). The acquisition unit 301 generates the device connection information 121 indicating the extracted connection relationship (1307). For example, the acquisition unit 301 uses a combination of identification information of a device having a port and identification information of another device having a port coupled to the above-mentioned port as the device connection information 121.

When it is determined that the acquisition of the LLDP information fails (NO in 1305), the acquisition unit 301 acquires, by the SNMP, NDP information which is managed as the MIB from each device (1308). The acquisition unit 301 checks whether the NDP information is successfully acquired (1309). For example, similarly to the LLDP information, the NDP information includes identification information of a device, identification information of each port, and identification information of a port of another device coupled to the port, which are defined by the SNMP.

When it is determined that the NDP information is successfully acquired (YES in 1309), the acquisition unit 301 analyzes the NDP information in accordance with the selected analytical rule 312 to extract a connection relationship between devices from the NDP information (1310). The acquisition unit 301 generates the device connection information 121 indicating the extracted connection relationship (1307).

When it is determined that the acquisition of the NDP information fails (NO in 1309), the acquisition unit 301 ends the process. According to the device connection information generation process of FIG. 13, even though the device connection information 121 is not input by the user, the device connection information 121 may be automatically generated.

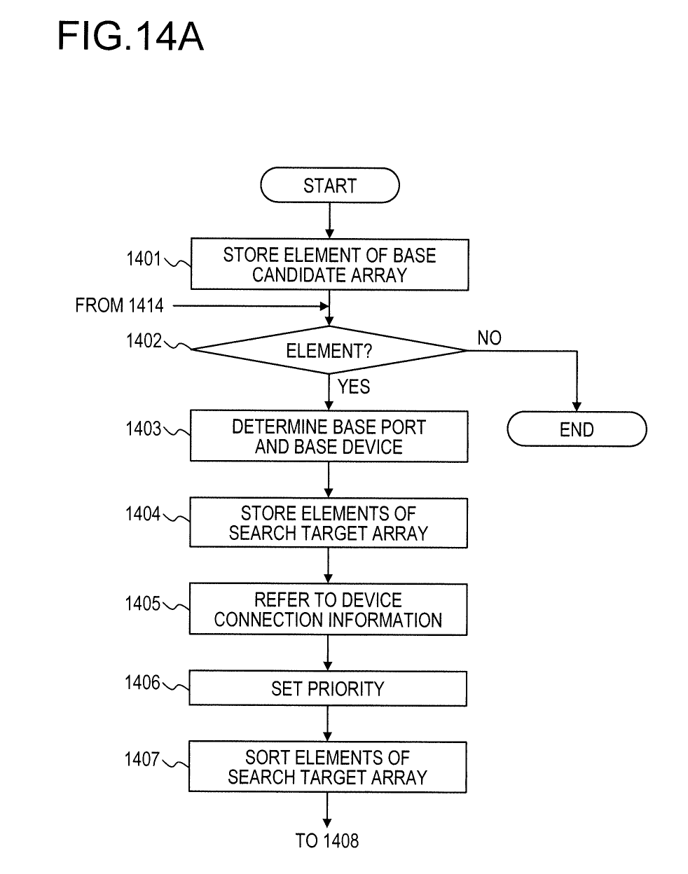

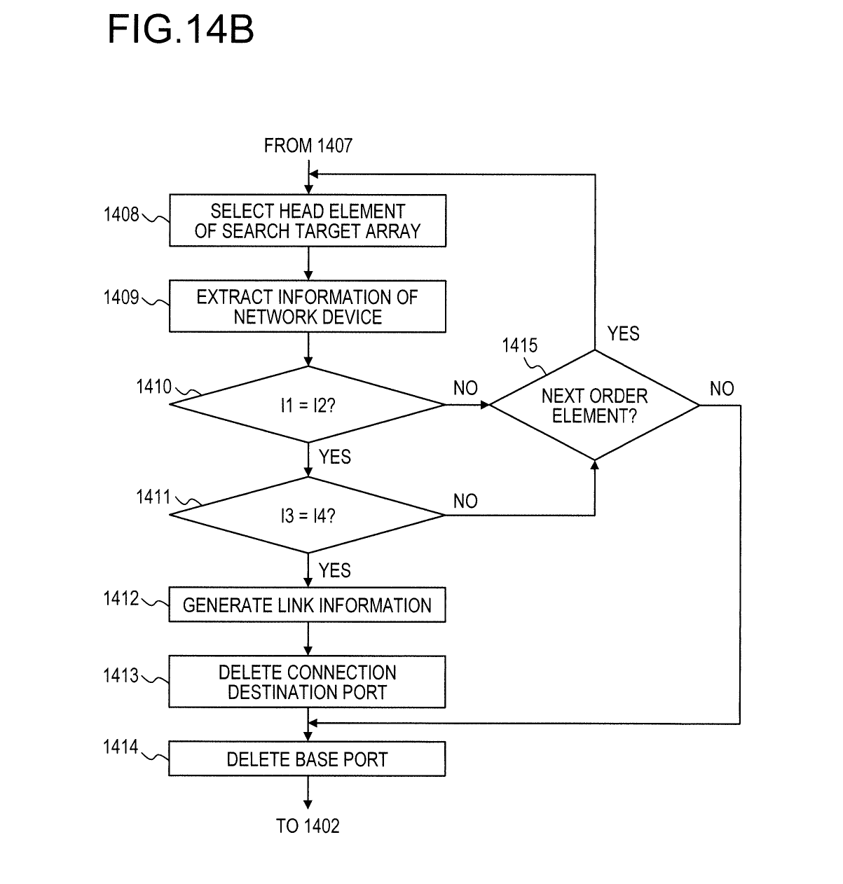

FIGS. 14A and 14B are flowcharts illustrating an example of a topology search process in 1206 of FIG. 12. First, the search unit 112 extracts a port having two or more learned MAC addresses from the MAC learning table management information 313. The search unit 112 stores identification information of the extracted port, identification information of the device having the port, and the number of MAC addresses learned for the port, as elements of a base candidate array provided in the storage unit 111 (1401).

For example, in the case of the MAC learning table management information 313 of FIG. 9, eight MAC addresses are learned for the port 5 of the switch α. Thus, information on the port 5 is stored in the base candidate array. Similarly, information on the ports 5 and 6 of the switch β and the port 5 of the switch γ is also stored in the base candidate array. Accordingly, four elements are stored in the base candidate array.

Next, the search unit 112 checks whether any element is stored in the base candidate array (1402). When it is determined that at least one element is stored in the base candidate array (YES in 1402), the search unit 112 selects an element having the largest number of MAC addresses among the elements of the base candidate array (1403). The search unit 112 determines a port indicated by the selected element as a base port and determines a device having the base port as a base device. The base device and the base port correspond to a specific device and a specific port, respectively.

In the case of the MAC learning table management information 313 of FIG. 9, the ports having the largest number of MAC addresses are the port 5 of the switch α and the port 5 of the switch γ. Accordingly, one of the two ports is determined as the base port.

Next, the search unit 112 extracts all network devices other than the base device, from the MAC learning table management information 313 and stores identification information of the extracted network devices as elements of a search target array provided in the storage unit 111 (1404).

For example, when the port 5 of the switch γ is determined as the base port, the switch γ is determined as the base device. Therefore, the switch α and the switch β which are network devices other than the switch γ are extracted from the MAC learning table management information 313 of FIG. 9 and two elements corresponding to the switches α and β are stored in the search target array.

Next, the search unit 112 refers to the device connection information 121 (1405) to set a priority to the respective elements of the search target array (1406). In this case, the search unit 112 sets a higher priority to an element indicating a connection destination device coupled to the base device than priorities of elements indicating devices other than the connection destination device.

For example, the search unit 112 sets a priority “1” to the connection destination device coupled to the base device and sets a priority “2” to a device coupled to the connection destination device. Further, the search unit 112 sets a priority obtained by increasing the set priority by one, to a device coupled to the device to which the priority has been set. In this case, the smaller the value of the set priority, the higher the priority.

When a priority is already set to a device coupled to a device to which a priority is set, the search unit 112 employs a higher priority of the priorities. The above-described process is repeated to set a priority to all elements of the search target array.

According to the device connection information 121 of FIG. 7, the switch β is coupled to the switch γ which is the base device, and the switch α is further coupled to the switch β. In this case, a priority “1” is set to the switch β and a priority “2” is set to the switch α.

Next, the search unit 112 sorts the elements of the search target array in order of priority from the highest priority (1407) and selects a head element of the sorted elements of the search target array (1408). The search unit 112 extracts information of a network device indicated by the selected element from the MAC learning table management information 313 (1409) and checks whether the following information I1 matches information 12 (1410).

I1: Plurality of MAC addresses learned for the base port

I2: Combination of MAC addresses learned for plurality of ports of the extracted network device

When it is determined that the information I1 matches the information I2 (YES in 1410), the search unit 112 checks whether the following information I3 matches information I4 (1411).

I3: Combination of MAC addresses learned for plurality of ports of the base device other than the base port

I4: Plurality of MAC addresses learned for one port of the extracted network device other than the plurality of ports indicated by information I2

When it is determined that the information I3 matches the information I4 (YES in 1411), the search unit 112 determines the port indicated by the information I4 as a connection destination port coupled to the base port (1412). The search unit 112 generates link information 315 including respective identification information of the base device, the base port, the extracted network device, and the connection destination port.

For example, when the base port is the port 5 of the switch γ, in the MAC learning table management information 313 of FIG. 9, the information I1 is A, B, C, D, E, F, G, and H. Further, when the head element of the search target array indicates the switch β, the information I2 corresponding to the ports 1 to 5 of the switch β is A, B, C, D, E, F, G, and H. Thus, the information I1 matches the information I2.

Next, the information I3 corresponding to the ports 1 to 4 of the switch γ other than the port 5 is I, J, K, and L. Further, the information I4 corresponding to the port 6 of the switch β other than the ports 1 to 5 is I, J, K, and L. Thus, the information I3 matches the information I4. Therefore, as illustrated in the second entry of FIG. 11, link information 315 indicating that the port 6 of the switch β and the port 5 of the switch γ are coupled to each other is generated.

Next, the search unit 112 deletes the element indicating the connection destination port from the base candidate array (1413) and deletes the element indicating the base port from the base candidate array (1414) to repeat 1402 and thereafter.

When it is determined that the information I1 does not match the information I2 (NO in 1410), the search unit 112 checks whether there is a next order element of the selected element in the search target array (1415). When it is determined that there is the next order element (YES in 1415), the search unit 112 repeats 1408 and thereafter on the next order element. When it is determined that there is no next order element (NO in 1415), the search unit 112 performs 1414 and thereafter.

When it is determined that the information I3 does not match the information I4 (NO in 1411), the search unit 112 performs 1415 and thereafter. When it is determined that all elements in the base candidate array are deleted (NO in 1402), the search unit 112 ends the process.

For example, it is assumed that after deleting the elements indicating the port 6 of the switch β and the port 5 of the switch γ from the base candidate array, the port 5 of the switch α is determined as the base port. In this case, in the MAC learning table management information 313 of FIG. 9, the information I1 is E, F, G, H, I, J, K, and L. Further, when the head element of the search target array indicates the switch β, the information I2 corresponding to the ports 1 to 4 and 6 of the switch β is E, F, G, H, I, J, K, and L. Thus, the information I1 matches the information I2.

Next, the information I3 corresponding to the ports 1 to 4 of the switch α other than the port 5 is A, B, C, and D. Further, the information I4 corresponding to the port 5 of the switch β other than the ports 1 to 4 and 6 is A, B, C, and D. Thus, the information I3 matches the information I4. Therefore, as illustrated in the first entry of FIG. 11, link information 315 indicating that the port 5 of the switch α and the port 5 of the switch β are coupled to each other is generated.

When the acquisition of LLDP information and the NDP information fails so that the device connection information 121 is not generated in the device connection information generation process of FIG. 13, the search unit 112 skips 1405 to 1407.

In the MAC learning table management information 313, in the case of a port which has one learned MAC address, the MAC address indicates the connection destination port. Therefore, the search unit 112 refers to the MAC address management information 314 to determine the port corresponding to the MAC address learned for the connection source port as the connection destination port and generates link information 315 indicating that the connection source port and the connection destination port are coupled to each other.

For example, when the connection source port is the port 1 of the switch α, in the MAC learning table management information 313 of FIG. 9, the MAC address learned for the port 1 of the switch α is A, and in the MAC address management information 314 of FIG. 10, the port corresponding to A is the port 1 of the PC P1. Therefore, as illustrated in the third entry of FIG. 11, link information 315 indicating that the port 1 of the switch α and the port 1 of the PC P1 are coupled to each other is generated.

According to the search process of FIG. 12, a device coupled to the base device is identified using the device connection information 121 and a search order of the device may be set to be earlier than that of the devices other than the device. Accordingly, the device coupled to the base device is searched prior to the other devices and the port of the device coupled to the base port of the base device may be obtained at a high speed, so that the processing time of the search process is shortened.

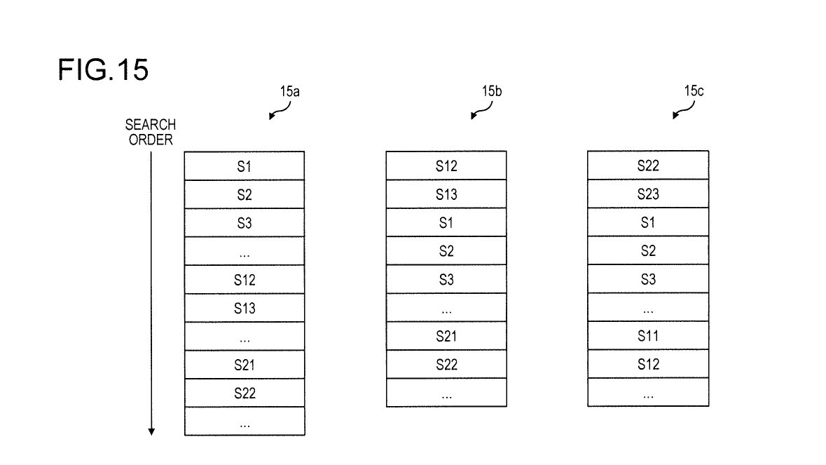

FIG. 15 illustrates an example of a search target array for a plurality of switches. S1, S2, S3, . . . , S11, S12, S13, . . . , and S21, S22, S23, . . . are identification information of the switches. A search target array 15a indicates a search target array in a case where the base device is the switch S11, in which identification information of switches other than the switch S11, which are extracted from the MAC learning table management information 313, is stored in a predetermined order.

Here, it is assumed that the switch S12 is coupled to the switch S11 and the switch S13 is coupled to the switch S12. In this case, when the search target array 15a is searched from a head element in the search order, the determination result of 1410 or 1411 on the switches S1 to S10 is NO. When the switch S12 is selected, the determination results in both 1410 and 1411 are YES for the first time and the link information 315 is generated. Therefore, it takes a long time until the link information 315 is generated.

In the meantime, a search target array 15b indicates a result obtained by sorting a search target array in order of priority from the highest priority when the priorities “1” and “2” are set for the switches S12 and S13, respectively, and a priority which is lower than the priority “2” is set to other switches. In this case, a head element of the search target array 15b indicates the switch S12, so that when the head element is selected, the determination results for both 1410 and 1411 are YES and the link information 315 is immediately generated.

A search target array 15c indicates a search target array when the base device is the switch S21, the switch S22 is coupled to the switch S21, and the switch S23 is coupled to the switch S22. In this case, the priorities “1” and “2” are set for the switches S22 and S23, respectively, a priority which is lower than the priority “2” is set to other switches, and the search target array is sorted in order of priority from the highest priority.

A head element of the sorted search target array 15c indicates the switch S22, so that when the head element is selected, the determination results for both 1410 and 1411 are YES and the link information 315 is immediately generated.

According to the topology search method of the related art, determinations corresponding to 1410 and 1411 are repeated by a round-robin manner for a plurality of switches, so that a processing time increases with an order of square of the number of switches existing within the search range. Therefore, the search process takes a long time in a communication network including several hundreds or thousands of switches.

For example, it is assumed that one thousand switches exist in a search range and an average number of ports having two or more learned MAC addresses is three. In this case, the total number of ports which are coupled to another switch is 3,000 and the total number of links between ports is 1,500.

It is also assumed that both of 1410 and 1411 are counted by one determination and a situation in which both determination results are YES is referred to as “hit”. In this case, the number of determinations is maximum in the following cases:

(p) when the search on 2,000 ports (1,000 links) ends, the remaining 1,000 ports (500 links) are included in the respective switches.

(q) when the search is performed with any arbitrary switch as a connection source, a switch at the last search order is always hit.

In this case, all the searches on the first 1,000 links are hit by 999—th determination, so that the number of determinations is obtained as follows.

999*1,000=999,000 (1)

During the search on the remaining 500 links, since the switches to be searched are reduced by two whenever the link is fixed, the number of determinations is obtained as follows.

999+997+995+ . . . +1=250,000 (2)

The assumed maximum number of determinations is obtained by adding the number of determinations of Equations 1 and 2 and is represented as follows.

999,000+250,000=1,249,000 (3)

With regard to this, when a switch which is coupled to the connection source switch is searched in preference to other switches using the device connection information 121, the assumed maximum number of determinations is significantly reduced. A case in which the average number of ports having two or more learned MAC addresses is three means that the average number of switches coupled to the connection source switch is three on average. When the switch is located at the head of the search target array, the search is hit by the third determination at worst.

In this case, all the searches on the first 2,998 ports (1,499 links) are hit by the third determination and the search on the last two ports (one link) is hit by the first determination, so that the number of determinations is as follows.

3*1,499+1=4,498 (4)

As described above, in the search process of the related art, approximately 1,250,000 determinations are made at maximum, but in the search process of FIG. 12, approximately 4,500 determinations are made at maximum and the number of determinations is reduced by approximately 99.7%. Therefore, it is possible to end the search process in a short time even in a communication network including a plurality of switches.

In the search process of FIG. 12, even though an error is included in the connection relationship between devices indicated by the device connection information 121, the error is corrected by referring to the MAC learning table management information 313 so that correct link information 315 is generated. Therefore, in order to check an error of a network diagram managed by the user, the search process of FIG. 12 may be used.

When the user inputs the device connection information 121, there is no need to input a connection relationship between ports, differently from the related art in which connection information is manually registered through the GUI or CLI. Therefore, the load of the user is small as compared with the manual registration of the connection information. In other words, in exchange for the small load, high versatility and high speed search process may be achieved.

The configuration of the information processing apparatus 101 of FIGS. 1 and 3 is merely illustrative, and some components may be omitted or modified depending on a purpose or a condition of the information processing apparatus 101. For example, when there is no need to output the link information 315, the output unit 302 of FIG. 3 may be omitted. When the entire communication network 321 is the search range, the search range information 311 may be omitted. Further, when the acquisition unit 301 does not generate the device connection information 121, the analytical rules 312 may be omitted.

Instead of the MAC address, another physical address which may uniquely identify a port in the communication network 321 may be used. For example, when an IP address is allocated to every port of each device, the IP address may be used as the physical address. In this case, instead of the MAC learning table, physical address learning information including the IP address learned for every port is used and instead of the MAC address management information 314, physical address management information indicating an IP address of each port may be used.

The flowcharts of FIG. 2 and FIGS. 12 to 14B are merely illustrative, and some processes may be omitted or modified depending on the configuration or condition of the information processing apparatus 101. For example, when the search range information 311 is omitted, 1201 of FIG. 12 may be omitted. Further, when the acquisition unit 301 does not generate the device connection information 121, 1204 and 1205 may be omitted.

In the topology search process of FIGS. 14A and 14B, instead of sorting the elements of the search target array in order of priority from the highest priority, an element indicating a connection destination device which is coupled to the base device at first may be processed and then an element indicating devices other than the connection destination device may be processed.

The communication network 321 of FIG. 4 and the search range of FIG. 6 are merely illustrative, and the search process may be performed on another communication network or search range. The search range information 311 of FIG. 5, the device connection information 121 of FIG. 7, the MAC learning tables of FIG. 8, the MAC learning table management information 313 of FIG. 9, the MAC address management information 314 of FIG. 10, the link information 315 of FIG. 11, and the search target arrays 15 of FIG. 15 are merely illustrative. Any of these may be modified depending on the configuration or condition of the communication network 321 to be processed and the information processing apparatus 101.

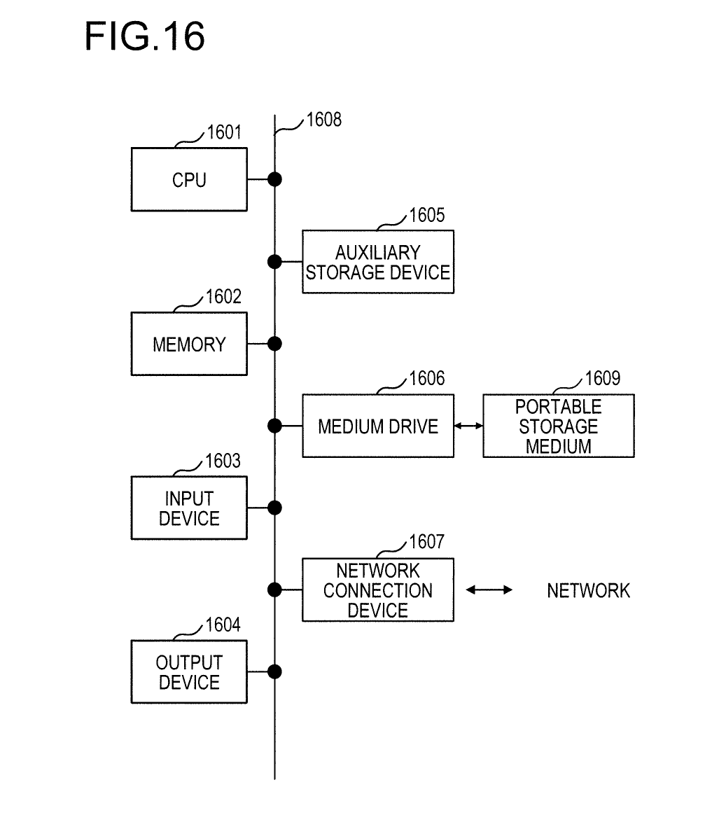

FIG. 16 illustrates an exemplary hardware configuration of the information processing apparatus 101 of FIGS. 1 and 3. The information processing apparatus of FIG. 16 includes a central processing unit (CPU) 1601, a memory 1602, an input device 1603, an output device 1604, an auxiliary storage device 1605, a medium drive 1606, and a network connection device 1607. These components are coupled to each other by a bus 1608.

The memory 1602 is, for example, a semiconductor memory such as a read-only memory (ROM), a random access memory (RAM), or a flash memory and stores therein a program and data used to perform search process. The memory 1602 may be used as the storage unit 111 of FIGS. 1 and 3.

The CPU 1601 (processor) executes a program using, for example, the memory 1602 to operate as the search unit 112 of FIGS. 1 and 3 and the acquisition unit 301 of FIG. 3.

The input device 1603 is, for example, a keyboard or a pointing device and is used to input an instruction or information from an operator or a user. The output device 1604 is, for example, a display device, a printer, or a speaker and is used to output an inquiry or an instruction, and a processing result to the operator or the user. The processing result may be the link information 315. The output device 1604 may be used as the output unit 302 of FIG. 3.

The auxiliary storage device 1605 is, for example, a magnetic disk device, an optical disk device, a magnetooptic disc device, or a tape device. The auxiliary storage device 1605 may be a hard disk drive. The information processing device may store the program and the data in the auxiliary storage device 1605 and use the program and the data by loading the program and the data onto the memory 1602. The auxiliary storage device 1605 may be used as the storage unit 111 of FIGS. 1 and 3.

The medium drive 1606 drives a portable recording medium 1609 and accesses recorded contents. The portable recording medium 1609 may be a memory device, a flexible disk, an optical disk, or a magnetooptic disk. The portable recording medium 1609 may be a compact disk read-only memory (CD-ROM), a digital versatile disk (DVD), or a universal serial bus (USB) memory. The operator or the user may store the program and the data in the portable recording medium 1609 and use the program and the data by loading the program and the data onto the memory 1602.

A computer-readable recording medium in which a program or data used to perform the search process is stored is a physical (non-transitory) recording medium such as the memory 1602, the auxiliary storage device 1605, or the portable recording medium 1609.

The network connection device 1607 is a communication interface which is coupled to a communication network such as a local area network or a wide area network to perform data conversion in the communication. The information processing apparatus may receive the program and the data from an external device through the network connection device 1607 and use the program and the data by loading the program and the data onto the memory 1602. The network connection device 1607 may be used as the output unit 302 of FIG. 3.

The information processing apparatus may receive the search range information 311 and a request for processing from the user terminal through the network connection device 1607 and perform the search process to transmit the link information 315 to the user terminal.

The information processing apparatus does not need to include all the components of FIG. 16 and some components may be omitted depending on the purpose or condition. For example, when the portable recording medium 1609 is not used, the medium drive 1606 may be omitted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
searching, by referring to device connection information indicating a connection destination device coupled to a first device among a plurality of devices included in a communication network, physical address learning information of the connection destination device in preference to physical address learning information of search target devices other than the connection destination device, the physical address learning information of a specific device including physical addresses learned for every port of the specific device, the search target devices being the plurality of devices other than the first device; and
obtaining a connection destination port coupled to a first port of the first device on basis of a result of the search.

2. The non-transitory computer-readable recording medium according to claim 1, the process further comprising:
storing a plurality of pieces of identification information indicating the respective search target devices in a search target array;
setting a priority of identification information of the connection destination device to be higher than a priority of identification information of the search target devices other than the connection destination device;
sorting the plurality of pieces of identification information stored in the search target array in order of priority from a highest priority; and
searching physical address learning information of the search target devices in accordance with an order indicated by a result of the sort.

3. The non-transitory computer-readable recording medium according to claim 1, the process further comprising:
acquiring a management information base of the plurality of devices;
analyzing the management information base using an analytical rule corresponding to respective types of the plurality of devices;
extracting connection relationships between the plurality of devices from the management information base; and
generating the device connection information on basis of the extracted connection relationships.

4. The non-transitory computer-readable recording medium according to claim 1, the process further comprising:
obtaining a port having a largest number of learned physical addresses from physical address learning information of the plurality of devices;
determining the obtained port as the first port; and
determining a second port of the connection destination device as the connection destination port, on basis of physical address learning information of the first device and the physical address learning information of the connection destination device, when physical addresses learned for the first port match a combination of physical addresses learned for ports of the connection destination device other than the second port and physical addresses learned for the second port match a combination of physical addresses learned for ports of the first device other than the first port.

5. An information processing apparatus, comprising:
a memory configured to store device connection information indicating a connection destination device coupled to a first device among a plurality of devices included in a communication network; and
a processor coupled to the memory and the processor configured to:
search physical address learning information of the connection destination device in preference to physical address learning information of search target devices other than the connection destination device on basis of the device connection information, the physical address learning information of a specific device including physical addresses learned for every port of the specific device, the search target devices being the plurality of devices other than the first device; and
obtain a connection destination port coupled to a first port of the first device on basis of a result of the search.

6. The information processing apparatus according to claim 5, wherein the processor is configured to:
store a plurality of pieces of identification information indicating the respective search target devices in a search target array;
set a priority of identification information of the connection destination device to be higher than a priority of identification information of the search target devices other than the connection destination device;
sort the plurality of pieces of identification information stored in the search target array in order of priority from a highest priority; and
search physical address learning information of the search target devices in accordance with an order indicated by a result of the sort.

7. The information processing apparatus according to claim 5, wherein the processor is configured to:
acquire a management information base of the plurality of devices;
analyze the management information base using an analytical rule corresponding to respective types of the plurality of devices;
extract connection relationships between the plurality of devices from the management information base; and
generate the device connection information on basis of the extracted connection relationships.

8. The information processing apparatus according to claim 5, wherein the processor is configured to:
obtain a port having a largest number of learned physical addresses from physical address learning information of the plurality of devices;
determine the obtained port as the first port; and
determine a second port of the connection destination device as the connection destination port, on basis of physical address learning information of the first device and the physical address learning information of the connection destination device, when physical addresses learned for the first port match a combination of physical addresses learned for ports of the connection destination device other than the second port and physical addresses learned for the second port match a combination of physical addresses learned for ports of the first device other than the first port.

9. An information processing method, comprising:
searching by a computer, by referring to device connection information indicating a connection destination device coupled to a first device among a plurality of devices included in a communication network, physical address learning information of the connection destination device in preference to physical address learning information of search target devices other than the connection destination device, the physical address learning information of a specific device including physical addresses learned for every port of the specific device, the search target devices being the plurality of devices other than the first device; and
obtaining a connection destination port coupled to a first port of the first device on basis of a result of the search.

10. The information processing method according to claim 9, further comprising:
storing a plurality of pieces of identification information indicating the respective search target devices in a search target array;
setting a priority of identification information of the connection destination device to be higher than a priority of identification information of the search target devices other than the connection destination device;
sorting the plurality of pieces of identification information stored in the search target array in order of priority from a highest priority; and
searching physical address learning information of the search target devices in accordance with an order indicated by a result of the sort.

11. The information processing method according to claim 9, further comprising:
acquiring a management information base of the plurality of devices;
analyzing the management information base using an analytical rule corresponding to respective types of the plurality of devices;
extracting connection relationships between the plurality of devices from the management information base; and
generating the device connection information on basis of the extracted connection relationships.

12. The information processing method according to claim 9, further comprising:
obtaining a port having a largest number of learned physical addresses from physical address learning information of the plurality of devices;
determining the obtained port as the first port; and
determining a second port of the connection destination device as the connection destination port, on basis of physical address learning information of the first device and the physical address learning information of the connection destination device, when physical addresses learned for the first port match a combination of physical addresses learned for ports of the connection destination device other than the second port and physical addresses learned for the second port match a combination of physical addresses learned for ports of the first device other than the first port.
